(19) United States
(12) Patent Application Publication
(10) Pub. No.: US 2010/0097623 A1
(43) Pub. Date: Apr. 22, 2010

(54) IMAGE FORMING APPARATUS, IMAGE FORMING METHOD, AND IMAGE FORMING PROGRAM

(75) Inventor: Hiroshi Ooya, Machida-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/571,896

(22) Filed: Oct. 1, 2009

(30) Foreign Application Priority Data
Oct. 22, 2008 (JP) 2008-271969

(51) Int. Cl. G06F 15/00; H04N 1/60; H04N 1/04

(52) U.S. Cl. 358/1.9; 358/530; 358/1.14; 358/474

(57) ABSTRACT

A printer not optically correcting bends and inclinations of scanning lines needs to execute such control as to electrically correct them. However, a conventional correction method has a problem that this correction causes an image defect such as an image streak or an uneven concentration in a specific area. A correction method of the present invention, when an input image has only one color, executes only correction by a second correction component which corrects distortions in a main scanning direction without executing correction by a first correction component which corrects bends and inclinations in a sub-scanning direction, and when an input image has two or more colors, executes both of correction by the first correction component and correction by the second correction component. This control can reduce the frequency of occurrence of an image defect.

### BACKGROUND OF THE INVENTION

1. Field of the Invention

The present invention relates to an image forming apparatus, and in particular to an image forming apparatus which has a plurality of light sources and photoconductors, forms different original images on the photoconductors, respectively, by causing a plurality of light beams emitted from the light sources to scan one by one, and transfers the original images onto the same recording medium to form an image.

2. Description of the Related Art

Conventionally, there is a so-called tandem system image forming apparatus capable of simultaneously forming original images corresponding to the colors of C, M, Y and K, respectively. The tandem system image forming apparatus has a plurality of photoconductors, exposes photoconductors corresponding to respective colors by a laser beam emitted from an exposure device based on image data signals resolved according to the colors, and then develops the photoconductors to form original images of respective colors. The image forming apparatus finally forms one color image by overlaying the original images of the colors onto the same transfer medium.

Here, one exemplary configuration of scanning exposure devices which emit laser beams for scanning and exposing photoconductors in the tandem system image forming apparatus will be described.

FIG. 1 shows an image forming apparatus 100 in which scanning exposure devices 102C, 102M, 102Y and 102K each deflecting and emitting a laser beam from a laser light source 103 by a polygon mirror 104 are arranged independently for respective four colors of C, M, Y and K. In the image forming apparatus 100 of this system, the scanning exposure devices 102C, 102M, 102Y and 102K each have a polygon mirror 104 rotated by a motor (not shown). The apparatus 100 performs exposure of monochrome images of the colors of C, M, Y and K onto the corresponding photoconductors 105 by causing laser beams to deflect and scan with the polygon mirrors 104, respectively. The monochrome images exposed onto the photoconductors 105 corresponding to the colors, respectively, are developed by their respective developing devices 106, and are then transferred to a transfer belt 108 which is a common transfer member among the colors at their respective transfer devices 107. A fixing device 109 is provided on the most posterior end side of the transfer belt 108, where the monochrome images of the colors are overlaid one by one on a recording medium 101 to finally form one color image.

However, there has been a problem that even if optical control is performed using such a mechanism, a scanning line is inclined due to an error or the like and an inclined image is output. In contrast to this, in a technology described in Japanese Patent Laid-Open No. 2006-297630, a method is adopted which improves a distortion of an image caused by an inclination (θ) of the main scanning line by adjusting the timing of starting to read data from a line buffer according to the amount of a positional shift (θ) in the case of monochrome.

In this conventional method, a conventional technology (see Japanese Patent Laid-Open No.H08-085236 (1996)) is used which measures the amount of a shift from a reference position from a specific patch drawn on a belt and corrects an inclination by converting image data to coordinates according to a numerical formula for correction obtained from the amount of the shift, in the case of full color.

The method described in Japanese Patent Laid-Open No. 2006-297630 has been effective in the case that scanning lines are not bent and are adjusted so that scanning is performed at a constant speed.

However, there has been a problem that such a function of correcting output positions of scanning lines needs parts and spaces for performing adjustment and the like of the light paths of laser beams to lenses and respective photoconductors and thereby increases cost.

Therefore, research for enabling correct printing by not optically correcting the output positions of scanning lines but electrically correcting them has been done in recent years.

A technology described in Japanese Patent Laid-Open No. 2006-289749 measures bends and inclinations in the sub-scanning direction of scanning lines in order to correct them, converts image data so as to cancel them, and then performs printing. However, the technology has a problem that steps are caused due to straight-line approximation of a quadratic curve showing bends at that time. Thus, interpolation processing is performed in order to make the steps inconspicuous. The image quality of an object in which steps are conspicuous such as a straight line or a character can be improved by performing interpolation processing. However, it is understood that there is a possibility that an image defect such as an uneven concentration is caused in a low concentration area especially in an image object such as a photograph by performing the interpolation processing. For this reason, the quality of an image is stabilized by performing interpolation processing in high concentration areas but not performing interpolation processing in low concentration areas. However, there has been a problem that when interpolation processing is switched between ON and OFF according to concentrations like this, an uneven concentration is caused in a portion where the concentration continuously changes, such as a gradation image.

The present invention aims to provide an image forming apparatus capable of reducing image defects caused when output positions of scanning lines are not optically corrected but electrically corrected and thereby forming a high-quality image.

### SUMMARY OF THE INVENTION

The present invention has been developed in order to achieve the above object, and aims to provide an image forming apparatus which causes each of a plurality of light beams to scan in amain scanning direction and a sub-scanning direction perpendicular to the main scanning direction to form an image having a plurality of colors, the apparatus comprising: a first correction component configured to correct bends and inclinations in the sub-scanning direction by performing conversion of image data so as to cancel bends and inclinations of the shapes of scanning lines when causing the light beams to scan in the main scanning direction; a second correction component configured to correct distortions in the main scanning direction of scanning lines; and a control component configured to execute both of correction by the first correction component and correction by the second correction component when an input image has two or more colors, and to execute only correction by the second correction component when an input image has only one color.

A gauging component can gauge the shapes of scanning lines of a plurality of light beams from the result of measurement by a measuring component and obtain curves which fit the shapes. This is equivalent to that the gauging component can gauge the amounts of bends of scanning lines of a plurality of light beams.

Further features of the present invention will become apparent from the following description of exemplary embodiments (with reference to the attached drawings).

### BRIEF DESCRIPTION OF THE DRAWINGS

FIG. 1 shows the configuration of scanning exposure devices which emit laser beams for scanning and exposing their respective drums in a tandem system laser beam printer which can be applied to the present invention;

FIG. 2 is a block diagram showing the whole configuration of an image processing system to which a data processing apparatus showing an embodiment of the present invention can be applied;

FIG. 3 is a cross-sectional view showing a rough structure of a laser beam printer which can be applied to the present invention;

FIG. 4 is a flowchart showing the flow of processing correcting distortions in a main scanning direction and bends and inclinations in a sub-scanning direction, which is one of embodiments of the present invention;

FIG. 5 shows examples of a UI giving an instruction for executing distortion/bend correction processing which are used in one of embodiments of the present invention;

FIG. 6 illustrates a distortion in a main scanning direction and correction thereof which are described in one of embodiments of the present invention; and

FIG. 7 shows the concept of transfer processing which is used in one of embodiments of the present invention.

### DESCRIPTION OF THE EMBODIMENTS

### First Embodiment

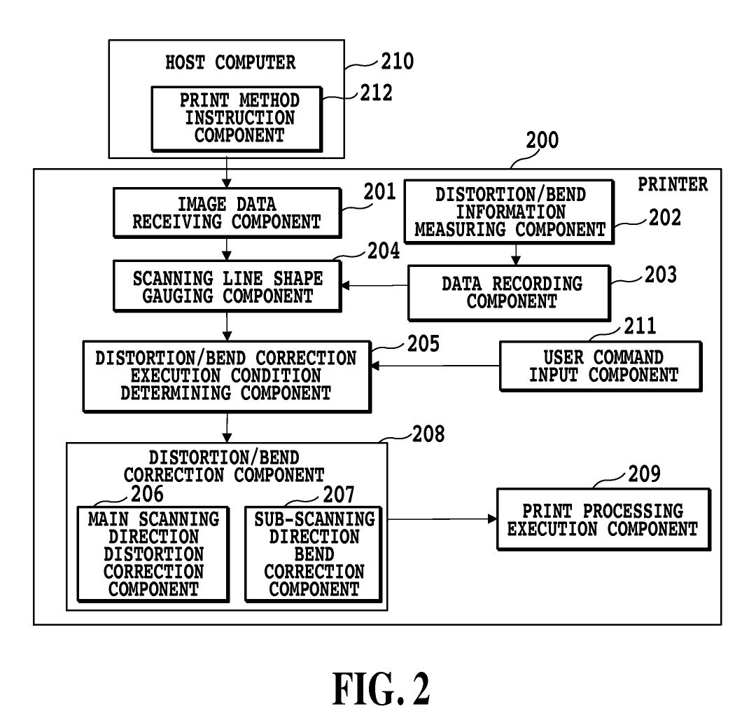

First, an image processing system to which the present invention is applicable will be described using FIG. 2. FIG. 2 is a block diagram showing the whole configuration of an image processing system including an image forming apparatus according to one embodiment of the present invention. In this embodiment, a printer (especially, a laser beam printer) is shown as an example of the image forming apparatus. However, the image forming apparatus may be an ink jet printer, a composite machine, or any other one.

Furthermore, in this embodiment describe below, components for realizing the present invention are all provided in one image forming apparatus. However, one image forming apparatus needs not have components for achieving the present invention, of course, and may have part of the components as, for example, a printer driver on a host computer (PC).

In FIG. 2, reference numeral 310 denotes a host computer. When printing is performed from an application or the like on the host computer 310, image data created by a printer driver (not shown) is transmitted to a printer 300.

Reference numeral 301 denotes an image data receiving component, which receives, in the printer 300, the image data transmitted by the host computer 310.

Reference numeral 302 denotes a distortion/bend information measuring component. The distortion/bend information measuring component 302 measures distortions in the main scanning direction and bends and inclinations in the sub-scanning direction perpendicular to the main scanning direction which are caused by not optically correcting bends and the like of light beams, and obtains the result of the measurement as distortion/bend information. Specifically, the distortion/bend information measuring component can measure, when each of a plurality of light beams has been caused to scan, how much a light beam of each color is shifted from an ideal straight line. Furthermore, the component can measure how much a scanning speed varies since the speed becomes not constant. Any measuring method such as a method of dividing a measurement range into smaller ranges such as those for each pixel to measure a lot or a method of expanding a measurement range for shortening of time to perform measurement may be used. However, when the distortion/bend information is invariant on the same printer, once the distortion/bend information is stored in a data recording component 303, the measuring component need not carry out measurement thereafter.

Reference numeral 303 denotes a data recording component, which is a hard disk, a NVRAM, or the like and records data such as distortion/bend information measured by the distortion/bend information measuring component 302.

Reference numeral 304 denotes a scanning line shape gauging component, which can obtain the entire shape of a scanning line from bend information (the magnitudes of a bend and an inclination) in the sub-scanning direction of the scanning line measured by the distortion/bend information measuring component 302. Specifically, the scanning line shape gauging component can gauge the shapes of scanning lines of a plurality of light beams from the above measurement result and obtain curves which fit the shapes. This is equivalent to that the scanning line shape gauging component can gauge the amounts of bends of scanning lines of a plurality of light beams.

Reference numeral 305 denotes a distortion/bend correction execution condition determining component, which determines whether to perform correction in each of the main scanning direction and the sub-scanning direction when an image is printed. The conditions of the determination include whether the image is monochrome or not, the magnitudes of distortions in the main scanning direction and bends and inclinations in the sub-scanning direction, and whether an instruction input about correction processing has been given from a user.

A main scanning direction distortion correction component 306 corrects distortions of an image caused in the main scanning direction. The details of distortions of an image in the main scanning direction and the processing for correcting them will be described later.

A sub-scanning direction bend correction component 307 obtains curves having such bends and inclinations as to cancel the shapes of scanning lines gauged by the scanning line shape gauging component 309, and reflects the shapes of the curves into image data. By this reflection, straight lines which are bent when output normally can be displayed like straight lines without being bent. The details of this processing will be described later.

Reference numeral 308 denotes a distortion/bend correction component, which consists of the main scanning direction distortion correction component 306 and the sub-scanning direction bend correction component 307. The distortion/bend correction component 308 performs distortion correction in the main scanning direction and bend correction in the sub-scanning direction according to a determination by the distortion/bend correction execution condition determining component 305.

Reference numeral 309 denotes a print processing execution component, which executes print processing of image data which has been corrected by the distortion/bend correction component 308.

Reference numeral 311 denotes a user command input component on the printer. A user can give an instruction or designation about how the user wants to perform correction processing by the distortion/bend amount correction component 308 in such a case that image data stored in the data recording component 303 or the like is printed.

Reference numeral 312 denotes a print method instruction component on the host computer 310. When printing is performed through an application or the like on the host computer 310, a user can perform setting also for correction processing by the distortion/bend correction component 308 like print layout, etc. The print method instruction component 312 may be implemented as one function of a printer driver (not shown) or may be implemented as an application other than it.

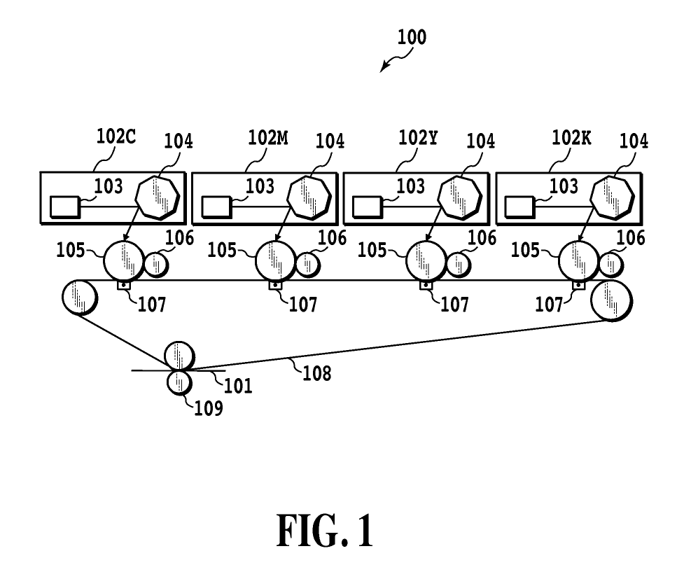

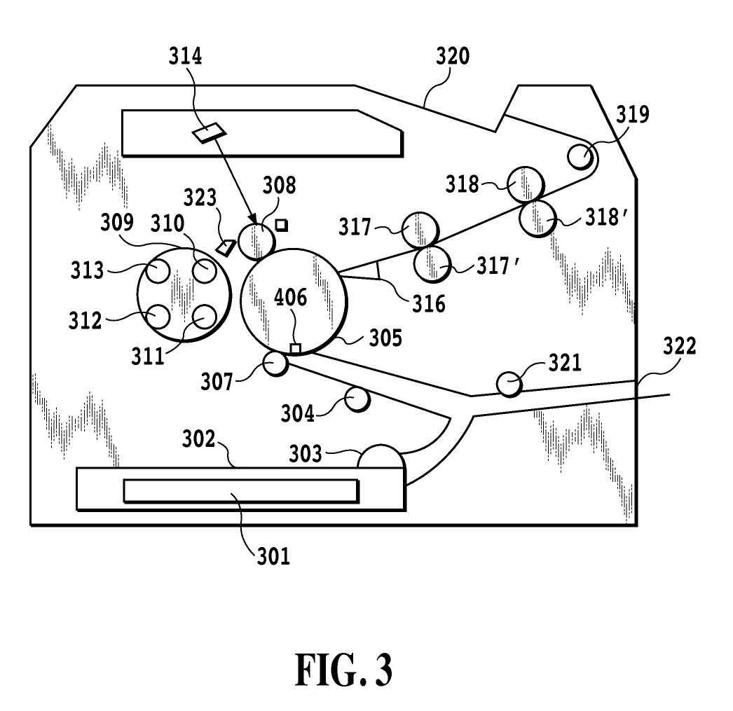

FIG. 3 is a cross-sectional view showing a rough structure of a laser beam printer. Although only one drum is drawn in the cross-sectional view of FIG. 3, a four-drum type is assumed as shown in FIG. 1 in the present invention.

In FIG. 3, reference numeral 401 denotes sheets of paper which are recording media, and reference numeral 402 denotes a paper cassette holding the sheets of paper 401. Reference numeral 403 denotes a cassette paper feed clutch, which separates only the top sheet of the sheets of paper 401 located on the paper cassette 402. The paper feed clutch 403 is shaped like a cam, and is rotated every time of paper feed by a drive component not shown in the figure and thereby transfers a sheet so that an end of it comes to the position of a paper feed roller 404 along with this separation, feeding one sheet every one rotation. When a sheet is transferred to the paper feed roller 404 by the paper feed clutch 403, the paper feed roller 404 rotates while pressing the sheet 401 lightly and transfer the sheet 401.

On the other hand, reference numeral 422 denotes a paper stand, and reference numeral 421 denotes a manual paper feed clutch. The above configuration enables not only paper feed from the above-mentioned paper cassette 402 but also individual manual paper feed from the paper feed stand 422.

Reference numeral 405 denotes a transfer drum, 406 denotes a gripper which pinches an end of a sheet of paper, and 407 denotes a transfer roller. When printing, the transfer drum 405 is being rotated at a predetermined speed, and when the gripper 406 on the transfer drum 405 comes to the position of an end of a sheet of paper by the rotation, the gripper pinches the end of the sheet. The sheet 401 is wrapped around the transfer drum 405 and further transferred by this operation and the rotation of the paper transfer roller 407.

Reference numeral 408 denotes a photoconductor drum; 409, a developing device supporting component; 410, an yellow (Y) toner developing device; 411, a magenta (M) toner developing device; 412, a cyan (C) toner developing device; and 413, a black (BK) toner developing device. The developing device supporting component 409 is rotated and thereby transfers a desired color toner developing device to a position where developing is possible for the photoconductor drum 408.

Reference numeral 414 denotes a laser driver. The laser driver 414 scans the surface of photoconductor drum 408 in the main scanning direction to form a latent image on main scanning lines while turning a semiconductor laser not shown in the figure on and off according to dot data for drawing sent out from a print control component not shown in the figure.

The photoconductor drum 408 is driven to rotate so that this latent image formation is synchronized with the position of a sheet of paper 401 on the transfer drum 405. In other words, one page of latent image is formed on the surface of the photoconductor drum 408 charged by a charging device not shown in the figure by exposure of the above-mentioned laser beam. The latent image on the photoconductor drum 408 is developed as a toner image by a predetermined color toner developing device of the developing devices 410, 411, 912 and 413, and then the toner image is transferred to the sheet 401 on the transfer drum 405.

In addition, toner images are overlaid on the sheet 401 on the transfer drum 905 by only as many operations similar to the above mentioned one as a necessary number of color toners. The sheet 401 on which necessary toner images have been transferred is separated from the transfer drum 405 by a transfer/separation claw 916. The toner images are then heated and fixed to the sheet by a pair of fixing rollers 917 and 417′, and the sheet is delivered to an output tray 420 through transfer rollers 418, 418′ and 419.

Reference numeral 423 denotes a concentration sensor, which detects the concentrations of toner images of YMCK patches formed on the photoconductor drum 908 with predetermined timing.

A controller (not shown) which controls the whole of the image forming apparatus is provided on the laser beam printer in FIG. 3, and performs processing of the components 301 to 309 in FIG. 2.

### [Details of Operation]

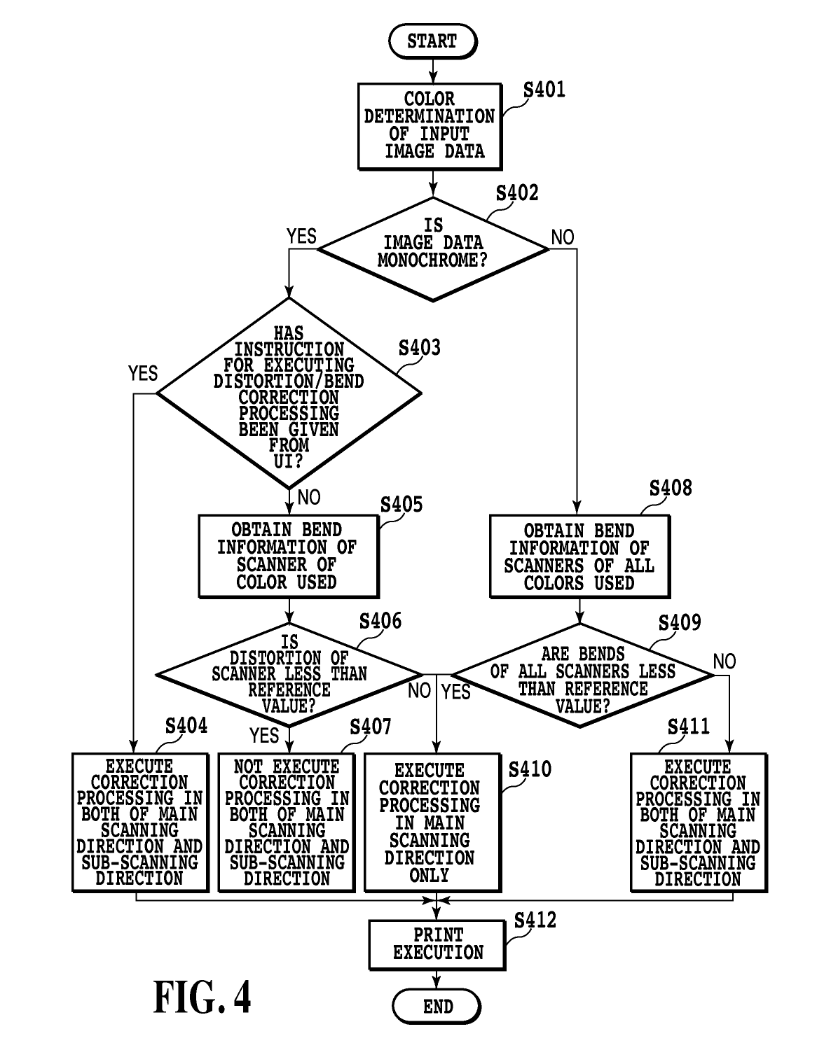

Subsequently, the operation of the image forming apparatus of this embodiment will be described in detail using FIG. 4.

FIG. 4 is a flow chart showing the operation of the image forming apparatus of this embodiment.

When a user has executed printing of an image, the distortion/bend correction execution condition determining component (305 in FIG. 2) makes a color determination of input image data (S501).

When it has been determined that the input image is monochrome (an image of only one of C, M, Y and K colors) as a result of the determination (S502), the distortion/bend correction execution condition determining component confirms whether or not an instruction for distortion/bend correction processing from a UI related to distortion/bend correction processing (S503) has been given. The UI may be either the user command input component (311 in FIG. 2) or the print method instruction component (312 in FIG. 2).

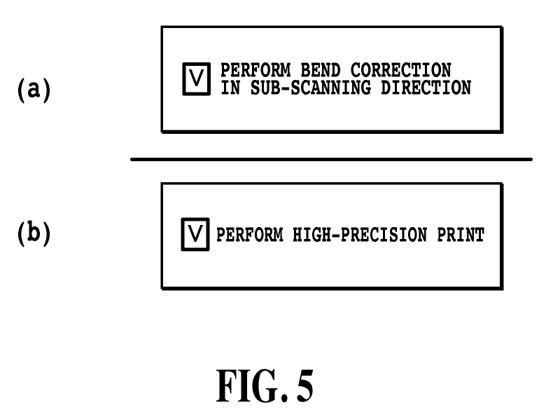

Furthermore, the UI may be one concretely indicating the contents of correction processing as shown in FIG. 5(a), or may be one performing a corresponding operation internally without indicating the contents of the processing as shown in FIG. 5(b). Furthermore, a method of giving an instruction for executing the processing is shown with an example using checkboxes in FIG. 5, but may be one using command inputs or the like without being restricted to one using checkboxes.

When an instruction for performing bend correction processing in the sub-scanning direction has been given from the UI, the distortion/bend correction component (308 in FIG. 2) performs correction processing in both of the main scanning direction and the sub-scanning direction (S504).

Here, the details of correction processing performed by the main scanning direction distortion correction component (306 in FIG. 2) and the sub-scanning direction bend correction component (307 in FIG. 2) included in the distortion/bend correction component will be described.

(Distortion Correction Processing in the Main Scanning Direction)

First, distortions in the main scanning direction will be described.

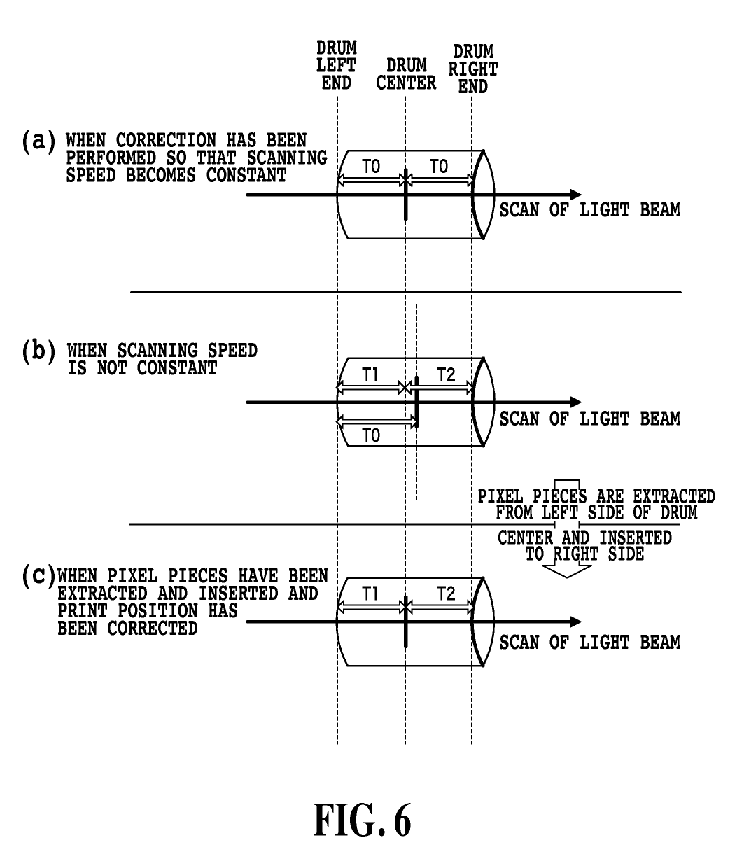

A printer which optically controls scans of a plurality of light beams adjusts light path differences, etc. by changing the positions and inclinations of lenses. When such adjustment is performed, scanning speeds of the light beams are constant as shown in FIG. 6(a), and for example, the scanning time on the left side of the drum and the scanning time on the right side of the drum are the same as T0 relative to the drum center. However, when scans of a plurality of light beams are not optically controlled, the scanning speeds become not constant as shown in FIG. 6(b) (ununiformity). For this reason, the scanning time on the left side of the drum and the scanning time on the right side of the drum become T1 and T2, respectively, which are different from each other (T1<T2 in this example). As a result of this, a line segment drawn just at the drum center in FIG. 6(a) is drawn at a position which is shifted to the right from the drum center in FIG. 6(b). In other words, this shows that an image on the left side relative to the drum center has been expanded and an image on the right side relative to the drum center has been contracted. This state will be referred to as a distortion in the main scanning direction.

The main scanning direction distortion correction component adjusts the expansion and contraction of the image, and performs distortion correction, as shown in FIG. 6(c), by extracting pixel pieces in units of less than one pixel from the left side where the image has been expanded and inserting the pixel pieces to the right side where the image has been contracted. By the way, in general, a distortion in the main scanning direction is small at an end of the drum and is largest at the center of the drum (in other words, pixels nearer the drum center are more expanded and contracted). For this reason, if pixel pieces are extracted and inserted at a regular interval, a print result is seen unlike an original image.

Thus, for example, the left half and right half of an image are divided into the same number of areas, and weights are assigned to the numbers of extracted and inserted pixel pieces according to the distances from the center (or end) of the drum. When weights are assigned like this and pixel pieces are extracted and inserted, the numbers of extracted and inserted pixel pieces in areas near an end of the drum are reduced and the numbers of extracted and inserted pixel pieces in areas near the drum center are increased, and thereby appropriate distortion correction can be performed.

In FIG. 6, information about distortions of distortion/bend information stored in the data recording component (303 in FIG. 2) is illustrated as scanning time. However, the information about distortions need not be scanning time and may be other information showing how much an image is actually distorted such as the numbers of pixels or distances.

(Bend Correction Processing in the Sub-scanning Direction)

Next, bend correction processing by a bend correction component in the sub-scanning direction will be described.

When bends and inclinations of light beams are optically controlled and are not corrected, an image bent in the sub-scanning direction is output depending on scanners attached to engines (scanning exposure devices). In order to correct this bend, the image has been converted beforehand in a direction opposite to the direction in which the image is bent (in other words, so as to cancel this bend). For this purpose, information about how much each color is bent is needed. Thus, bends and inclinations are measured by the distortion/bend information measuring component (302 in FIG. 2) before performing correction, and are stored in the data recording component (303 in FIG. 2) as bend information.

The shape of each scanning line is obtained by the scanning line shape gauging component (304 in FIG. 2) from bend information included in the distortion/bend information stored in the data recording component. The shape of a bent scanning line can be calculated by obtaining the amounts of shifts from ideal positions of the scanning line with respect to three or more pixels of the pixels on the scanning line. Since an ideal scanning line is a straight line, the amounts of shifts can be translated into distances from the straight line. The amounts of shifts can be represented by distances from reference positions indicating which color is printed at which position when predetermined patches are printed. In actuality, the amounts of shifts can be obtained by measuring, when predetermined patches are printed, how much printed patches are shifted from the reference positions. If it is understood that how much shifts from ideal positions of the scanning line are there with respect to three pixels on the scanning line, the shape of the scanning line is understood by connecting the shifted three points, and the equation of the curve (straight line) of the scanning line can be obtained from the coordinates of the three points.

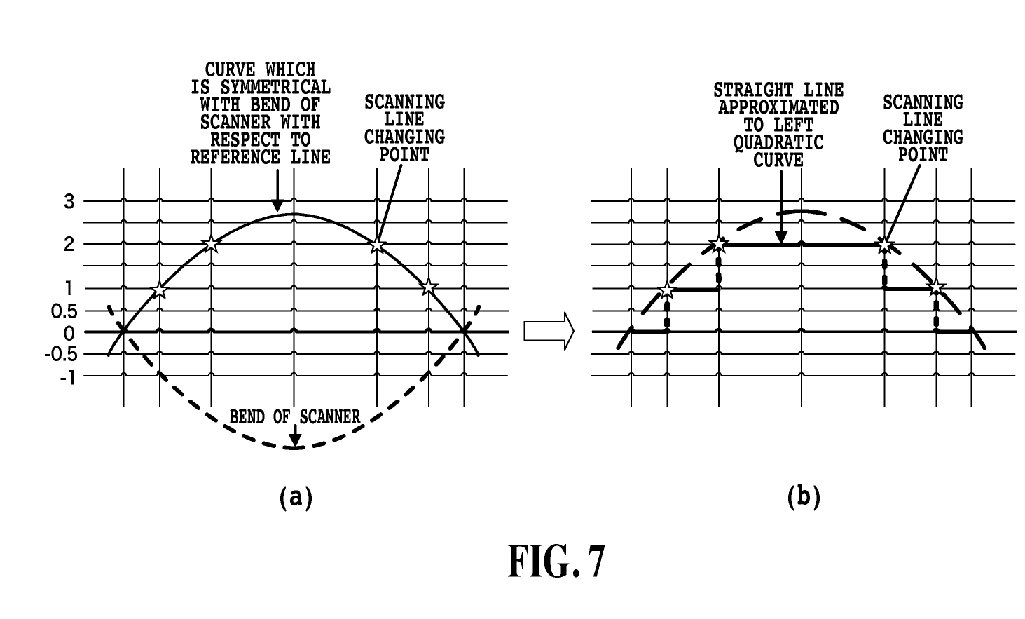

Here, it is assumed to be understood that the scanning line has become a curve like a dotted line in FIG. 7(a) when the shape of the scanning line has been obtained. At that time, a curve (a solid line in FIG. 7(a)) is obtained which is symmetrical with the bent scanning line with respect to the ideal scanning line. If the obtained curve (referred to as a scanning line bend cancel curve hereinafter) is printed with the same printer, the bends and inclinations are cancelled and a straight line which is originally desired to be drawn can be drawn. Thus, the whole of the image data is converted so that bends are cancelled by scanning line bend cancel curves.

However, since the image data has been sampled by pixel, the shapes of scanning line bend cancel curves cannot be reflected to conversions as they are. Thus, a curve is shown by raising or lowering image data originally existing on the same line by one line at some points. As the result of this approximation of the solid line in FIG. 7(a), a solid line in FIG. 7(b) is obtained. Here, it is referred to as “transfer” that image data exiting on the same line is raised or lowered by one line, and a point where “transfer” is done is referred to as “transfer point”.

The shapes of scanning line bend cancel curves can be substantially reflected to image data by using this transfer. In this connection, in FIG. 7(b), values in the sub-scanning direction of the curve (referred to as X coordinate values (values in the vertical direction in the figure) hereinafter, the unit of which is line) are approximated to zero (line) when being zero or more and less than one, and are approximated to one (line) when being one or more and less than two, for example. In other words, in the example of the same figure, points where coordinates have changed from one to two on the scanning line bend cancel curve are assumed to be transfer points.

Transfer points (in other words, points where a straight is divided and raised or lowered by one line) are not uniquely determined, and a different approximation can be made by setting other transfer points.

However, steps are conspicuous at transfer points in an object such as a straight line only by doing such transfer, so that interpolation processing is actually performed before and after the step to make the step inconspicuous. On the other hand, in a low concentration area, for example, a specific (screen) pattern is repeated by applying halftone treatment such as dither to a low concentration image data, and thereby a low concentration is represented. However, the screen pattern is collapsed by executing interpolation for it and the thickness of a line is changed, so that the concentration at a portion for which interpolation has been executed appears to be changed. Since a problem such as occurrence of an uneven concentration before and after a transfer point may arise like this, interpolation processing is not performed in a low concentration area.

Here, the description returns to FIG. 4. When no instruction for performing correction processing in the sub-scanning direction has been given from the UI at step S503, printing is performed without performing correction in the sub-scanning direction. Since such correction in the sub-scanning direction is not performed, interpolation processing, ON/OFF determination of interpolation, and an image defect caused by them, which have become problems, can be prevented from arising. In addition, since transfer is also not done, an image defect such as a streak caused by transfer can be prevented from arising.

Although scanning lines are kept bent by not performing correction processing in the sub-scanning direction, bends of scanning lines are inconspicuous in the case of a monochrome image, so that priority is given to preventing a more conspicuous image defect from happening.

At step S505, when input image data is a color image of one color (only one of C, Y, M and K colors), distortion/bend information about a scanner attached to an engine (scanning exposure device) corresponding to one color of the input image is obtained from the data recording component. After obtaining data, the distortion/bend correction execution condition determining component determines whether a distortion in the main scanning direction is less than a reference value based on the distortion/bend information (S506). If a distortion in the main scanning direction is less than the reference value as a result of the determination, correction processing in both of the main scanning direction and the sub-scanning direction is not performed (S507). If a distortion in the main scanning direction is the reference value or more, only distortion correction in the main scanning direction is performed (S510).

On the other hand, when input image data is a color image using two (two of C, Y, M and K colors) or more colors, distortion/bend information of scanners attached to the engines of all colors is obtained from the data recording component (S508), and it is determined whether bend information in the sub-scanning direction is less than a reference value (S509). If the magnitudes of bends and inclinations in the sub-scanning direction are less than a reference value, correction in the sub-scanning direction is not performed and only distortion correction processing in the main scanning direction is performed (S510). If a bend in the sub-scanning direction is a reference value or more, correction processing in both of the main scanning direction and the sub-scanning direction is executed as before (S511).

By performing control like this, in the case of a monochrome image, printing is performed without performing correction in the sub-scanning direction and any image defect can be prevented from arising. Although scanning lines are kept bent by not performing correction in the sub-scanning direction, in the case of a monochrome image, bends of scanning lines are inconspicuous, so that priority is given to preventing any more conspicuous image defect from happening.

On the other hand, in the case of an image using two (two of C, Y, M and K colors) or more colors, if correction in the sub-scanning direction is not performed, scanning lines are kept bent and thereby color shift happens between two colors, so that correction in the sub-scanning direction is performed. With respect to distortion correction in the main scanning direction, no image defect is caused, so that correction is performed regardless of an image.

When an input image has especially only one color, correction in the sub-scanning direction is not particularly performed, and thereby image defects which may arise along with correction can be prevented from happening. As a result, it becomes possible to output a high-quality image while keeping a cost low.

### Second Embodiment

In the second embodiment, all components for achieving the present invention are not included in one image forming apparatus. For example, the present invention is applied to a host-based printer (processing in FIG. 4 is performed by a host computer). In the case of a host-based printer, it is assumed that a host computer (PC) determines whether an image is monochrome or not (color/monochrome determination is also acceptable), and performs image data conversion for correcting bends in the sub-scanning direction, and the like.

For this reason, an instruction for executing distortion/bend correction processing from the UI is given through the print method instruction component 312. Furthermore, 301, 304 and 305 in FIG. 2 are in the host computer, and distortion/bend information measured by the distortion/bend amount measuring component 302 should be notified to both of the controller and the host computer. The host computer to which distortion/bend information has been notified makes determinations of steps S503, S505 and 5506 (S508 and S509 in the case of a color image) in FIG. 4 by the same method as described in the first embodiment.

When the host computer has determined that bend correction in the sub-scanning direction is necessary as a result of the determination of a distortion/bend correction execution condition at the host computer side, the host computer performs conversion of image data. Converted image data is transmitted to the controller of the printer. At the same time, it is also notified to the controller whether distortion correction in the main scanning direction is necessary. When distortion correction in the main scanning direction is necessary, the controller performs the correction and executes printing. Thus, the same effect as in the case that components for achieving the present invention are all provided in one image forming apparatus is obtained.

The above-mentioned embodiment is only one example and may be realized with any other configuration.

### Third Embodiment

In the first embodiment, at step S506 in FIG. 4, the magnitude of a distortion in the main scanning direction is confirmed, and it is determined whether or not correction processing in the main scanning direction is performed. In contrast to this, correction processing in the main scanning direction may be always performed without confirming the magnitude of a distortion in the main scanning direction.

Likewise, at step S509 in FIG. 4, the magnitudes of bends and inclinations of scanners attached to engines (scanning exposure devices) of all colors are confirmed, and it is determined whether or not correction processing in the sub-scanning direction is performed. Without restricted to this, correction processing may be always performed without confirming the magnitudes of bends and inclinations in the sub-scanning direction.

Furthermore, at step S509 in FIG. 4, the magnitudes of distortions in the main scanning direction of scanners attached to engines of all colors are also confirmed, and if the distortions in the main scanning direction of scanners attached to engines of all colors are less than a reference value, correction processing in the main scanning direction may not be performed.

In other words, a system may be constructed which can change whether correction processing in the sub-scanning direction and the main scanning direction is performed or not according to the magnitudes of bends and inclinations in the sub-scanning direction of scanners attached to engines of all colors and/or the magnitudes of distortions in the main scanning direction.

### Fourth Embodiment

In the first embodiment, a command for selecting whether or not bend correction in the sub-scanning direction is executed is provided as shown in FIG. 5 as an example of a UI for executing distortion/bend correction processing at step S503 in FIG. 4. However, the present invention is not limited to such embodiment. For example, an instruction whether distortion correction processing in the main scanning direction is executed may be given alone from an UI component such as 311 or 312 in FIG. 2. Alternatively, an instruction whether correction processing in the main scanning direction and correction processing in the sub-scanning direction are both executed at the same time may be given.

In other words, a system may be constructed which can give an instruction whether correction is performed in each of the main scanning direction and the sub-scanning direction from a UI component and operates exactly according to an input from the UI component (giving a high priority to the instruction).

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-271969, filed Oct. 22, 2008, which is hereby incorporated by reference herein in its entirety.

What is claimed is:

1. An image forming apparatus which causes each of a plurality of light beams to scan in a main scanning direction and a sub-scanning direction perpendicular to the main scanning direction to form an image having a plurality of colors, the apparatus comprising:
a first correction component configured to correct bends and inclinations in the sub-scanning direction by performing conversion of image data so as to cancel bends and inclinations of the shapes of scanning lines when causing the light beams to scan in the main scanning direction;
a second correction component configured to correct distortions in the main scanning direction of scanning lines; and
a control component configured to execute both of correction by the first correction component and correction by the second correction component when an input image has two or more colors, and to execute only correction by the second correction component when an input image has only one color.

2. The image forming apparatus of claim 1, further comprising:
a print method instruction component configured to be capable of instructing whether to execute each of correction by the first correction component and correction by the second correction component; and
a correction execution condition determining component configured to determine whether the print method instruction component has specified whether to execute each of correction by the first correction component and correction by the second correction component,
wherein the control component controls execution of correction by the first correction component and correction by the second correction component, based on the determination by the correction execution condition determining component.

3. The image forming apparatus of claim 2, further comprising,
a measuring component configured to measure information about a bend, inclination, and distortion of a light beam of each color when causing each of the plurality of light beams to scan in the main scanning direction, wherein:
the correction execution condition determining component further determines whether a bend and inclination of a light beam of each color measured by the measuring component are less than a reference value and whether a distortion of a light beam of each color measured by the measuring component is less than a reference value; and
the control component performs control so as not to execute correction by the first correction component when the correction execution condition determining component has determined that a bend and inclination of a light beam of each color measured by the measuring component are less than a reference value, and performs control so as not to execute correction by the second correction component when the correction execution condition determining component has determined that a distortion of a light beam of each color measured by the measuring component is less than a reference value.

4. The image forming apparatus of claim 3, wherein the correction execution condition determining component gives priority to a correction execution condition designated by the print method instruction component when the correction execution condition designated by the print method instruction component is different from a correction execution condition determined from a measurement result measured by the measuring component.

5. An image forming method of an image forming apparatus which causes each of a plurality of light beams to scan in a main scanning direction and a sub-scanning direction perpendicular to the main scanning direction to form an image having a plurality of colors, the method comprising the steps of:
firstly correcting bends and inclinations in the sub-scanning direction by performing conversion of image data so as to cancel bends and inclinations of the shapes of scanning lines caused when causing the light beams to scan in the main scanning direction;
secondly correcting distortions in the main scanning direction of scanning lines; and
controlling execution of both of correction by the first correction step and correction by the second correction step when an input image has two or more colors and execution of only correction by the second correction step when the input image has only one color.

6. A program on a computer readable medium for an image forming method of an image forming apparatus which causes each of a plurality of light beams to scan in a main scanning direction and a sub-scanning direction perpendicular to the main scanning direction to form an image having a plurality of colors, the method comprising the steps of:
firstly correcting bends and inclinations in the sub-scanning direction by performing conversion of image data so as to cancel bends and inclinations of the shapes of scanning lines caused when causing the light beams to scan in the main scanning direction;
secondly correcting distortions in the main scanning direction of scanning lines; and
controlling execution of both of correction by the first correction step and correction by the second correction step when an input image has two or more colors and execution of only correction by the second correction step when the input image has only one color.
